(19) United States
(12) Patent Application Publication
(10) Pub. No.: US 2020/0115093 A1
(43) Pub. Date: Apr. 16, 2020

(54) DEVICE AND METHOD FOR AUTOMATICALLY ORIENTING CONTAINERS ENTERING A LABELING MACHINE

(71) Applicant: P.E. LABELLERS S.P.A., Porto Mantovano (IT)

(72) Inventor: Nicola SCHINELLI, Mantova (IT)

(21) Appl. No.: 16/603,854

(22) PCT Filed: Apr. 6, 2018
(86) PCT No.: PCT/EP2018/058835

§ 371 Date: Oct. 9, 2019

(30) Foreign Application Priority Data
Apr. 11, 2017 (IT) 102017000039651

(51) Int. Cl. B65C 9/06; B65C 9/02; G01N 21/90

(52) U.S. Cl. CPC B65C 9/067; B65C 9/02; G01N 21/9081; G01N 21/9045; G01N 21/9036

(57) ABSTRACT

A device for automatically orienting containers to be labeled entering a labeling machine, which includes at least one emitter device, which is adapted to emit electromagnetic radiation toward the containers, elements of detecting the electromagnetic radiation reflected by the containers, and processing and control elements adapted to identify the position of the optically detectable defects on each one of the containers; the emitter device including a lighting module with an emitting face which has at least one first emitting portion and is associated with a plurality of first sources of electromagnetic radiation of a first type which are designed to activate/deactivate the first emitting portion; the emitting face of the lighting module further including a second emitting portion, and an associated plurality of second sources of electromagnetic radiation of a second type, different from the first type, which are designed to activate/deactivate the second emitting portion.

The present invention relates to a device and a method for automatically orienting containers entering a labeling machine.

As is known, containers, such as bottles or vials, made of plastic material or glass, are produced by molding.

Owing to such production technique, the containers have defects: for example, at the regions where the mold dies meet, a pair of longitudinal join lines is formed, also known as “flash lines” in the jargon; such lines, substantially parallel to the central axis of the container, are more or less evident depending on the quality of the molding; furthermore, as a function of the material of the container and of the precision of the molding, other types of localized defects can form, such as depressions or protrusions or the like.

In the labeling of containers the need is felt to avoid applying the labels by superimposing them on the regions where such flash lines are.

To this end optical devices have been proposed for automatically orienting the containers, arranged upstream of the labeling machines; however, such devices have been found to not be fully satisfactory in carrying out the identification of the position of the flash lines on the containers, especially if these are insufficiently visible.

An example of such conventional solutions is shown in US patent application US2010/0290695.

Such conventional device is provided with a lighting unit in which there are areas with different levels of lighting; the transition between the two areas of different lighting occurs gradually and along vertical transition areas; the lighting unit then cooperates with an imaging unit which acquires images of the containers in order to identify the position of the flash lines and orient the container. The areas of the lighting unit of this conventional device are illuminated by light sources such as LEDs.

A limitation of this solution is linked to the fact that the join lines are sometimes not easily recognizable, meaning that errors or delays are generated in the labeling process.

The Applicant, following tests and trials, has also noted that some types of materials of the container, some types of imperfections or join lines cannot be easily illuminated by the LEDs in US2010/0290695 or more generally by the conventional solutions, with the consequence that such defects are not correctly recognized/located.

The aim of the present invention is to provide a device and a method for automatically orienting containers entering a labeling machine, which makes it possible, automatically, to carry out, in any situation, the correct identification of the position of the defects and more particularly (but not only) of the flash lines on containers to be labeled and as a consequence carry out the positioning of the containers, prior to feeding them to a labeling machine, so that the labeling machine can apply the labels on the containers without superimposing them on the flash lines.

Within this aim an object of the invention is to provide a device and a method for automatically orienting containers entering a labeling machine which is capable of identifying the position of the defects and more particularly (but not only) of the flash lines, even if they are not easily visible.

Another object of the invention is to provide a device for automatically orienting containers entering a labeling machine which is easily and practically implemented, so as to be low cost.

This aim and these and other objects which will become better apparent hereinafter are all achieved by a device for automatically orienting containers entering a labeling machine, according to the invention, as defined in the appended claims.

Further characteristics and advantages of the present invention will become better apparent from the description of some preferred, but not exclusive, embodiments of the device according to the invention, which are illustrated by way of non-limiting example in the accompanying drawings wherein:

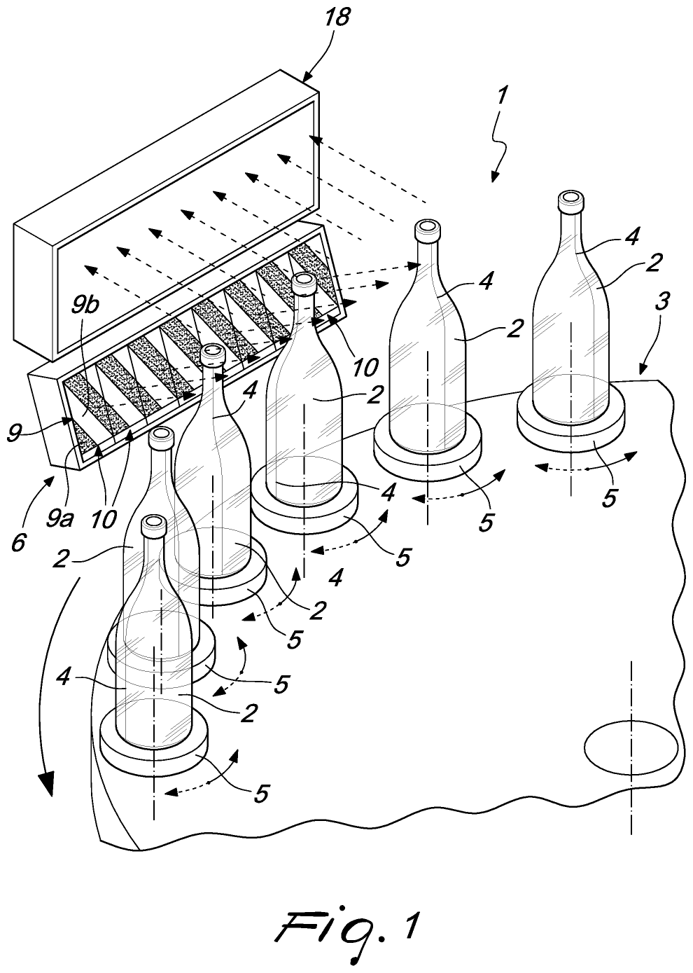

FIG. 1 is a schematic perspective view of the device according to the invention;

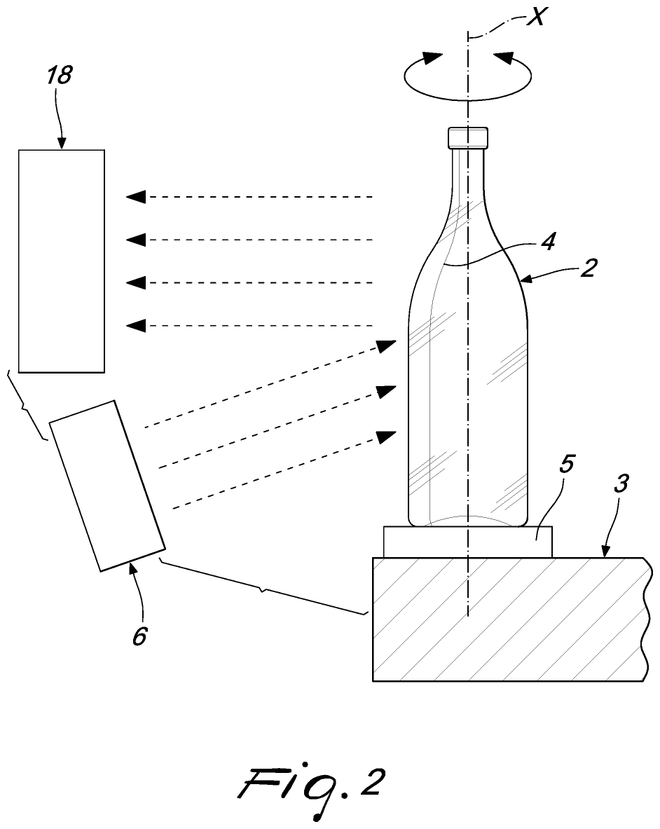

FIG. 2 is a schematic side view of the device according to the invention;

FIG. 3 is a schematic front elevation view of the device according to the invention;

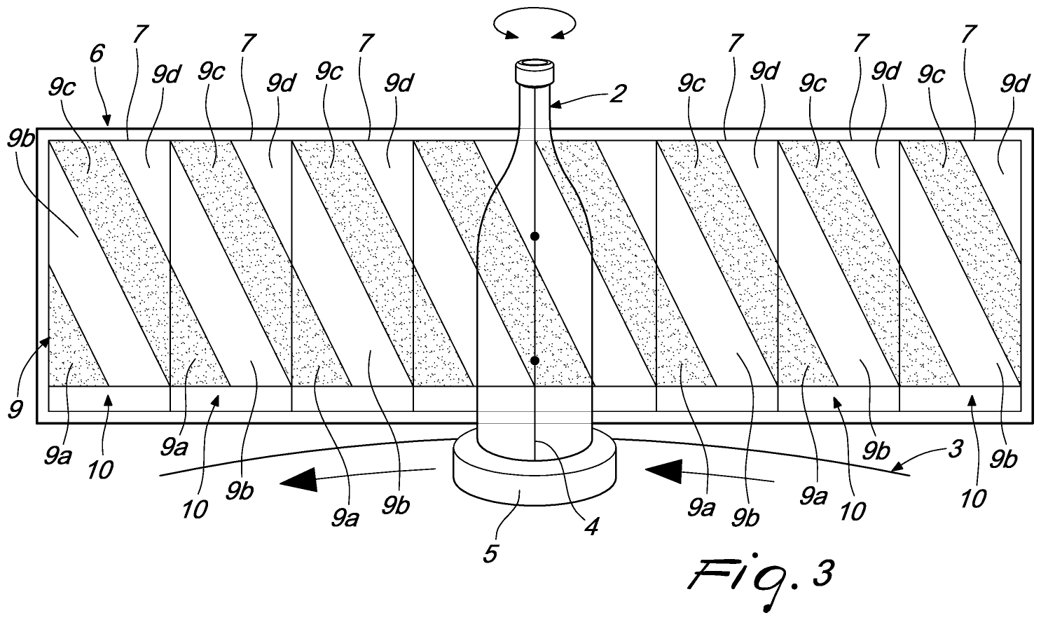

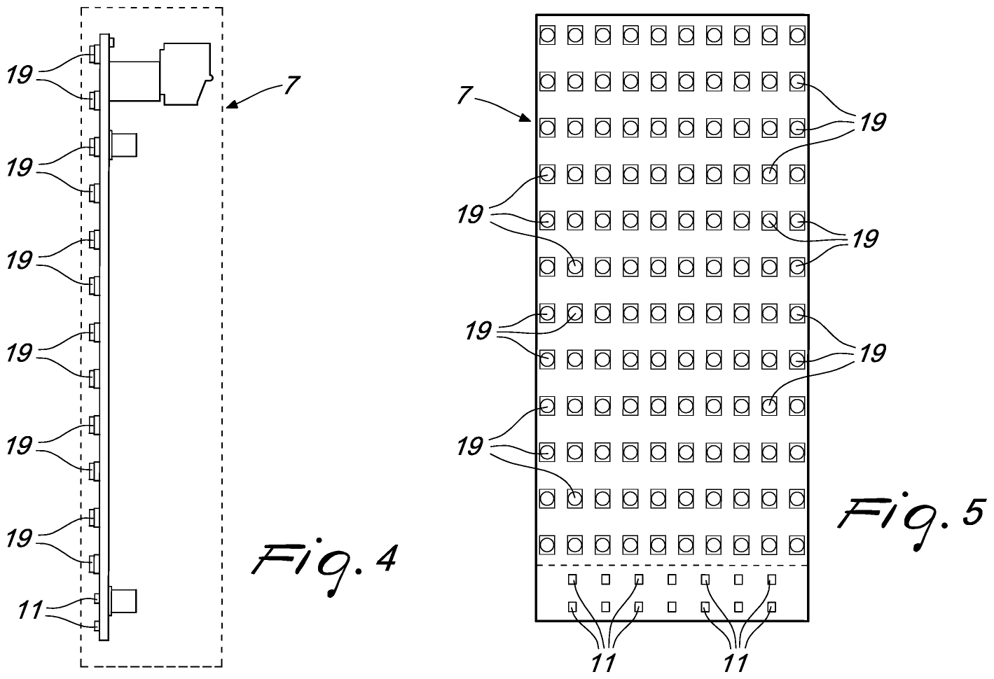

FIGS. 4 and 5 are respectively a side view and a front view of a part of a lighting module of the invention;

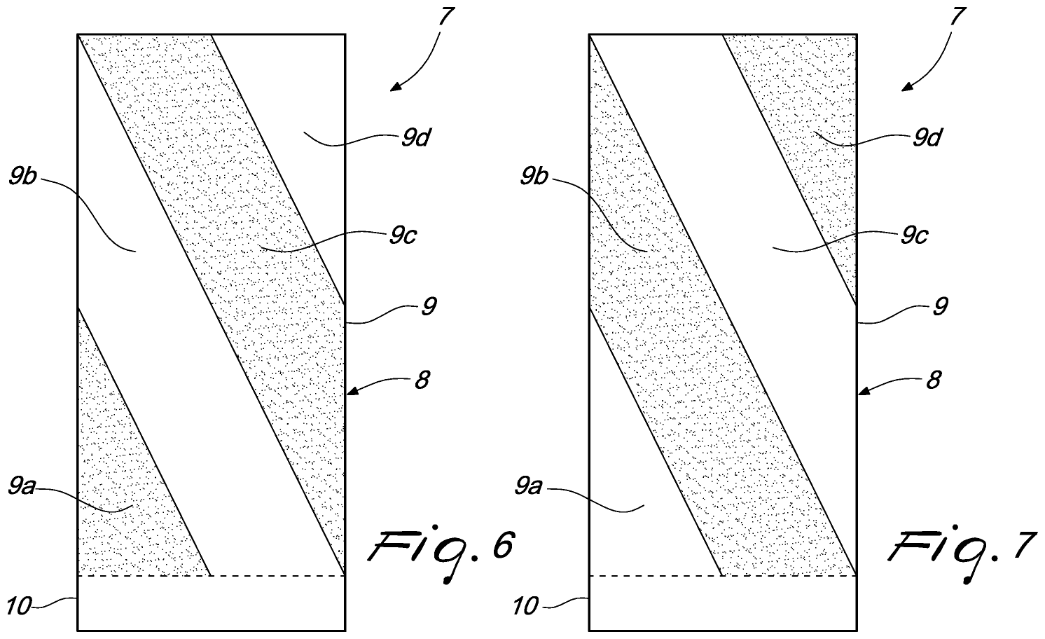

FIGS. 6 and 7 are front views of an emitting face of a lighting module of the invention.

With reference to the figures, the device 1 is intended to automatically orient containers to be labeled 2 entering a labeling machine.

The containers 2, produced by molding, usually have optically detectable defects 4, such as flash lines or protrusions or depressions, at which it is not suitable to affix the label, as explained above.

The defects are “optically detectable” in the sense that they can be detected by way of techniques of the optical type, such as incident, refracted or reflected radiation, including of the type that is not visible to the human eye.

The device 1 comprises, among other things, a conveyor for feeding 3 the containers 2 and rotation means 5 which are adapted to turn each one of the containers 3 about its own axis.

The conveyor for feeding 3, in the preferred solution, is a carousel that carries the rotation means 5, which are motorized patterns that can rotate with respect to the carousel proper.

The device 1 also comprises at least one emitter device, generally indicated with the reference numeral 6, which is adapted to emit electromagnetic radiation toward the containers 2 and means of detecting 18 the electromagnetic radiation reflected by said containers, so as to enable the detection of the defects 4 and consequently orient the containers before their entry to the labeling unit, in order to prevent the labels from being superimposed on those defects 4.

To this end, cooperating with the emitter 6, with the means of detecting 18 and with the rotation means 5, the device 1 comprises processing and control means which are adapted to identify, on the basis of the reflected electromagnetic radiation detected by said means of detecting 18, the position of the optically detectable defects 4 on each one of the containers 2 and to actuate then the rotation means 5 in order to bring each one of the containers 2 to a preset position as a function of the identified position of the corresponding defects 4.

Turning now to describe the emitter device 6, this is facing the carousel for a preferred arc of its extension and comprises at least one lighting module 7.

In the non-limiting example given, in particular, the emitter device 6 comprises a plurality of lighting modules 7 (specifically, eight) arranged mutually side-by-side, aligned and cooperating.

Hereinafter the description will refer to one module 7, but it should be noted that if there is more than one module, they are all provided in a similar manner.

The lighting module 7 comprises an emitting face 8 which has at least one first emitting portion 9 and a second emitting portion 10, preferably laterally adjacent and coplanar.

The emitting face 8 preferably comprises an emission screen made of transparent or translucent material.

The first emitting portion 9 is associated with a plurality of first sources of electromagnetic radiation 19 of a first type which are designed to activate/deactivate the first emitting portion 9, preferably selectively, as will shortly be better described.

The second emitting portion 10, separate from the first emitting portion 9, is associated with a plurality of second sources of electromagnetic radiation 11 of a second type, different from the first type, which are designed to activate/deactivate the second emitting portion 10.

The first and second sources 19 and 11 are “associated” with the respective emitting portions 9 and 10 in the sense that they are mounted so as to project the respective electromagnetic radiation so that it passes through the respective emitting portions 9 and 10, which are directed, in use, toward the container 2 that at that moment, following the rotation of the carousel 3, is transiting before the emitting face 8.

Advantageously, the first sources of electromagnetic radiation 19 are infrared LEDs while the second sources of electromagnetic radiation 11 are ultraviolet LEDs.

As a consequence, the means of detecting 18 are intended to detect electromagnetic radiation both of the first and of the second type and, in the preferred case, both infrared radiation and ultraviolet radiation.

There is no reason why the first or the second sources cannot be adapted to emit visible electromagnetic radiation, such as for example white light, or why there cannot be third sources for emitting visible electromagnetic radiation. In such case, the means of detecting 18 will also be capable of detecting visible electromagnetic radiation.

The combination of different types of electromagnetic radiation (and, preferably, infrared and ultraviolet, but optionally also white light) emitted by the module 7 makes it possible in fact to detect with greater precision different types of defects 4 and/or markers that are present on containers made of a different material, by virtue of the fact that some defects 4 and/or markers (depending for example on their position and/or on their orientation and/or on their size and/or on the material of the container 2) proved (in tests carried out by the Applicant) to be more precisely locatable with one or the other type of radiation.

For example, ultraviolet radiation has been found to be suitable for detecting markers applied to containers and constituted by “logos” printed with special paints.

According to an optional and advantageous characteristic, the first emitting portion 9 is substantially divided into oblique emitting areas 9a, 9b, 9c, 9d, which in the non-limiting example are four in number, but more generally may be two or more in number.

The emitting areas 9a, 9b, 9c, 9d are oblique with reference to a longitudinal axis of extension of the lighting module 7.

In the non-limiting example shown, the lighting module 7 is rectangular, with the shorter sides which constitute the horizontal (upper and lower) bases of the rectangle with reference to a mounted condition.

The first sources of electromagnetic radiation 19 are mutually functionally connected in groups, each group being associated with a respective oblique emitting area 9a, 9b, 9c, 9d of the emitting portion 9.

In particular, in a front elevation view, like the one in FIG. 6 or 7, each group of first sources of electromagnetic radiation 19 is arranged behind the respective oblique emitting area 9a, 9b, 9c, 9d, so that the radiation emitted by each group strike the respective oblique emitting area 9a, 9b, 9c, 9d.

Each group has first sources 19 which are mutually capable of being switched on/switched off together, so as to bring the corresponding oblique emitting area 9a, 9b, 9c, 9d to an active/inactive condition.

In particular, as shown in FIGS. 6 and 7, the groups of first sources 19 relating to alternating oblique areas 9a and 9c or 9b and 9d are functionally connected together, so as to define active alternating oblique areas (such as 9b, 9d in FIG. 6 or 9a, 9c in FIG. 7) or inactive alternating oblique areas (such as 9a, 9c in FIG. 6 or 9b, 9d in FIG. 7) which are respectively generated by groups of first sources 19 which are on or off.

In operation, the groups of sources 19 associated with the alternating oblique areas are subsequently switched on and switched off repeatedly, so as to generate a continuous alternation; this is why it was indicated earlier that the first emitting portion 9 is “selectively” activated/deactivated.

In the preferred case wherein there is a plurality of lighting modules 7 which are mutually side by side, as in the non-limiting example shown, the oblique emitting areas 9a, 9b, 9c, 9d of two adjacent lighting modules 7 are mutually continuous and the groups of first sources 19 which are associated with continuous oblique emitting areas 9a, 9b, 9c, 9d of two adjacent lighting modules 7 are mutually functionally connected.

This is in order to switch on/switch off the entire oblique areas that extend over two adjacent modules, so as to define alternating oblique areas 9a, 9c; 9b, 9d which are active or inactive and continuous between two adjacent lighting modules 7.

The second emitting portion 10 extends longitudinally perpendicular with respect to a longitudinal axis of extension of the lighting module 7, preferably proximate to the lower base of the module 7.

Differently from the foregoing description, the second sources of electromagnetic radiation 11 are functionally connected together, so that they can all be switched on/off in order to bring the entire second emitting portion 10 to an active/inactive condition.

The method of the invention entails at least the steps of:

a. rotating a container 2 about its own axis;

b. bombarding each of the containers 2 with electromagnetic radiation of at least one type;

c. detecting, using means of detecting 8, the electromagnetic radiation reflected by each one of the containers 2;

d. identifying, by way of processing and control means, the position of the optically detectable defects 4 of the container 2 on the basis of the electromagnetic radiation acquired by the means of detecting 18;

e. optionally rotating the container 2 in order to bring it to a respective preset angular position as a function of the identified position of the optically detectable defects 4.

Advantageously, according to the invention, the step b. provides for bombarding the containers 2 with electromagnetic radiation of a first type and of a second type that is different from the first type.

Preferably, the electromagnetic radiation of the first type is infrared radiation and the electromagnetic radiation of the second type is ultraviolet radiation.

Preferably the electromagnetic radiation of the first type is generated cyclically in oblique bands emitted by corresponding oblique emitting areas 9a, 9b, 9c, 9d that are mutually arranged in an alternating activated or deactivated condition.

The invention thus conceived is susceptible of numerous modifications and variations, all of which are within the scope of the appended claims.

In practice the materials employed, provided they are compatible with the specific use, and the dimensions and shapes, may be any according to requirements.

Moreover, all the details may be substituted by other, technically equivalent elements.

The disclosures in Italian Patent Application No. 102017000039651 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-10. (canceled)

11. A device for automatically orienting containers to be labeled entering a labeling machine, each one of the containers having optically detectable defects, which comprises:
a conveyor for feeding the containers;
rotation means which are adapted to rotate each one of said containers about its own axis;
at least one emitter device which is adapted to emit electromagnetic radiation toward said containers;
means of detecting the electromagnetic radiation reflected by said containers; and
processing and control means adapted to identify, on the basis of the reflected electromagnetic radiation detected by said means of detecting, the position of the optically detectable defects on each one of said containers and to actuate said rotation means in order to bring each one of said containers to a preset position as a function of the identified position of the corresponding defects;
wherein the emitter device comprises a lighting module, which in turn comprises:
an emitting face, which has at least one first emitting portion and an associated plurality of first sources of electromagnetic radiation of a first type, which are designed to activate/deactivate the first emitting portion;
wherein the emitting face of the lighting module further comprises a second emitting portion which is distinct from the first emitting portion, and an associated plurality of second sources of electromagnetic radiation of a second type, different from the first type, which are designed to activate/deactivate the second emitting portion.

12. The device according to claim 11, wherein the first sources of electromagnetic radiation are infrared LEDs and the second sources of electromagnetic radiation are ultraviolet LEDs.

13. The device according to claim 11, wherein at least one first emitting portion is substantially divided into emitting areas which are oblique with respect to a longitudinal axis of extension of the lighting module, said first sources of electromagnetic radiation being mutually functionally connected in groups, each group being associated with a respective oblique emitting area and capable of being switched on/switched off so as to bring the corresponding oblique emitting area to an active/inactive condition.

14. The device according to claim 13, wherein the groups of first sources relating to alternating oblique areas are functionally connected together, so as to define active or inactive alternating oblique areas which are respectively generated by groups of first sources which are on or off.

15. The device according to claim 11, wherein the second emitting portion extends longitudinally at right angles to a longitudinal axis of extension of the lighting module.

16. The device according to claim 11, wherein the second sources of electromagnetic radiation are functionally connected together, so that they can all be switched on/off in order to bring the entire second emitting portion to an active/inactive condition.

17. The device according to claim 14, wherein the emitter device comprises a plurality of lighting modules which are arranged mutually side by side, the oblique emitting areas of two adjacent lighting modules being mutually continuous and the groups of first sources which are associated with continuous oblique emitting areas of two adjacent lighting modules being mutually functionally connected, in order to be capable of being switched on/switched off, so as to define alternating oblique areas which are active or inactive and continuous between two adjacent lighting modules.

18. The device according to claim 11, wherein said conveyor for feeding comprises a carousel which supports said rotation means, said emitter device facing the carousel for a preferred arc of its extension.

19. A method for automatically orienting containers to be labeled entering a labeling machine, each container having optically detectable defects, said method comprising the steps of:
a. rotating a container about its own axis;
b. bombarding each of said containers with electromagnetic radiation;
c. detecting, using means of detecting, the electromagnetic radiation reflected by each one of said containers;
d. identifying, by way of processing and control means, the position of said optically detectable defects of the container on the basis of the electromagnetic radiation acquired by said means of detecting;
e. optionally rotating said container in order to bring it to a respective preset angular position as a function of the identified position of said optically detectable defects;
wherein step b. provides for bombarding the containers with electromagnetic radiation of a first type and of a second type that is different from the first type.

20. The method according to claim 19, wherein the electromagnetic radiation of the first type is infrared radiation and the electromagnetic radiation of the second type is ultraviolet radiation.
